(19) United States
(12) Patent Application Publication
(10) Pub. No.: US 2026/0257485 A1
(43) Pub. Date: Sep. 3, 2026

(54) LIQUID EJECTION APPARATUS, LIQUID LEVEL HEIGHT CONTROL METHOD, AND STORAGE MEDIUM

(71) Applicant: Konica Minolta, Inc., Tokyo (JP)

(72) Inventor: Shiori TSUGAWA, Nagaokakyo-shi (JP)

(21) Appl. No.: 19/548,428

(22) Filed: Feb. 24, 2026

(30) Foreign Application Priority Data
Mar. 3, 2025 (JP) 2025-033180

(51) Int. Cl. B41J 2/175; B41J 2/17; B41J 2/18; B41J 2/19

(52) U.S. Cl. CPC B41J 2/17566; B41J 2/1707; B41J 2/17596; B41J 2/18; B41J 2/19; B41J 2202/07

(57) ABSTRACT

A liquid ejection apparatus includes: a liquid ejector that ejects liquid; a liquid deliverer that delivers liquid to the liquid ejector; and a hardware processor. The liquid deliverer includes a first liquid storage and a second liquid storage that store liquid, and a first liquid channel including a first liquid deliverer that delivers the liquid in the first liquid storage to the second liquid storage. The hardware processor senses an abnormality of the first liquid channel based on a liquid delivery by the first liquid deliverer. The hardware processor is configured to, in a case in which a predetermined condition is satisfied, reduce a liquid level height in the second liquid storage by causing the liquid in the second liquid storage to be discharged.

### CROSS-REFERENCE TO RELATED APPLICATION

The entire disclosure of Japanese Patent Application No. 2025-033180, filed on Mar. 3, 2025, including description, claims, drawings and abstract is incorporated herein by reference.

### BACKGROUND OF THE INVENTION

### Technical Field

The present disclosure relates to a liquid ejection apparatus, a liquid level height control method, and a storage medium.

### Description of Related Art

Conventionally, a liquid ejection apparatus including a liquid ejection section to eject liquid is known. The liquid ejection section is connected to a plurality of liquid storage sections storing liquid, by a channel in which liquid flows. Then, the liquid ejection section ejects the liquid fed from the liquid storage section via the channel. Therefore, if an abnormality exists in the channel, this interferes with ejection of the liquid by the liquid ejection section.

Therefore, for example, Japanese Unexamined Patent Publication No. 2016-112882 describes an inkjet recording apparatus as one embodiment of a liquid ejection apparatus. The inkjet recording apparatus delivers ink from a first ink tank to a second ink tank and measures a change in an ink amount in the second ink tank to sense a presence or absence of an abnormality in the channel connecting both ink tanks.

However, when the liquid is delivered in order to sense an abnormality in the channel, the liquid level height of the liquid storage section on a downstream side in the liquid delivery direction rises, and a risk of the liquid overflowing increases. When the liquid overflows from the liquid storage section, for example, an air flow path provided to adjust a pressure value in the liquid storage section is contaminated. When the air flow path is contaminated, it is necessary to stop an operation in order to perform cleaning or the like, and productivity of liquid ejection is reduced.

Note that providing a known liquid amount sensor in the liquid storage section for sensing the liquid level height can prevent overflow of the liquid in the liquid storage section. However, in the case of providing the liquid amount sensor, it is common to turn off power of the liquid ejection apparatus at a timing at which it is sensed that the liquid level height has reached a predetermined value, to discharge the liquid from the liquid storage section, and then to restart the liquid ejection apparatus. Therefore, even in a case where the liquid amount sensor is provided, a decrease in productivity of the liquid ejection cannot be avoided.

### SUMMARY OF THE INVENTION

The present disclosure has been made in view of such circumstances. It is an object of the present invention to provide a liquid ejection apparatus, a liquid level height control method, and a storage medium, which are capable of suppressing both of overflow of liquid in a liquid storage section due to liquid delivery accompanied by sensing of an abnormality in a channel and a reduction in productivity accompanied by drive stop.

In order to solve the above-described problem, according to one aspect of the present disclosure, a liquid ejection apparatus according to one aspect of the present disclosure includes,
a liquid ejector that ejects liquid;
a liquid deliverer that delivers liquid to the liquid ejector; and
a hardware processor,
wherein,
the liquid deliverer includes a first liquid storage and a second liquid storage that store liquid, and a first liquid channel including a first liquid deliverer that delivers the liquid in the first liquid storage to the second liquid storage,
the hardware processor senses an abnormality of the first liquid channel based on a liquid delivery by the first liquid deliverer, and
the hardware processor is configured to, in a case in which a predetermined condition is satisfied, reduce a liquid level height in the second liquid storage by causing the liquid in the second liquid storage to be discharged.

According to another aspect of the present disclosure, a liquid level height control method executed by a liquid ejection apparatus including a liquid ejector that ejects liquid; and a liquid deliverer that delivers liquid to the liquid ejector, wherein the liquid deliverer includes a first liquid storage and a second liquid storage that store liquid, and a first liquid channel including a first liquid deliverer that delivers the liquid in the first liquid storage to the second liquid storage, the liquid level height control method including:
sensing an abnormality of the first liquid channel based on a liquid delivery by the first liquid deliverer, and
in a case in which a predetermined condition is satisfied, adjusting and reducing a liquid level height in the second liquid storage by causing the liquid in the second liquid storage to be discharged.

According to another aspect of the present disclosure, a non-transitory computer-readable storage medium storing a program that causes a computer of a liquid ejection apparatus including a liquid ejector that ejects liquid; and a liquid deliverer that delivers liquid to the liquid ejector, wherein the liquid deliverer includes a first liquid storage and a second liquid storage that store liquid, and a first liquid channel including a first liquid deliverer that delivers the liquid in the first liquid storage to the second liquid storage, the program causing the computer to perform:
sensing an abnormality of the first liquid channel based on a liquid delivery by the first liquid deliverer, and
in a case in which a predetermined condition is satisfied, adjusting and reducing a liquid level height in the second liquid storage by causing the liquid in the second liquid storage to be discharged.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a cross-sectional side view of an inkjet recording apparatus;

FIG. 2 is a schematic configuration diagram of a liquid delivery section;

FIG. 3 is a schematic cross-sectional view of a liquid level sensor and a sub-tank;

FIG. 4 is a block diagram of the inkjet recording apparatus;

FIG. 5 is a flowchart of channel abnormality sensing processing;

FIG. 6 is a flowchart of liquid level height adjustment processing;

FIG. 7 is a graph illustrating a pressure difference between a first sub-tank and a second sub-tank and an accumulated value of an ink movement amount over time;

FIG. 8 is a schematic configuration diagram of a liquid delivery section according to a modification example; and

FIG. 9 is a schematic configuration diagram of the liquid delivery section according to the modification example.

### DETAILED DESCRIPTION

Hereinafter, one or more embodiments of the present disclosure will be described with reference to the drawings. However, the scope of the invention is not limited to the disclosed embodiments.

Hereinafter, a liquid ejection apparatus according to an embodiment of the present disclosure will be described in detail with reference to the drawings. However, the scope of the invention is not limited to the illustrated examples. In the following description, components having the same function and configurations are denoted by the same reference numerals, and the description thereof will be omitted.

### Overall Configuration of Inkjet Recording Apparatus

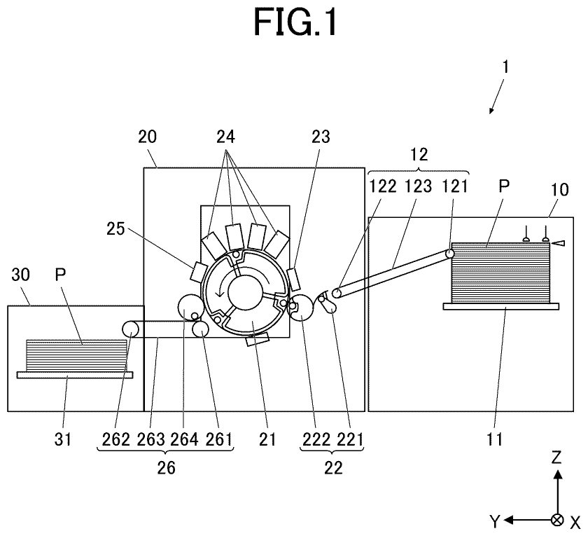

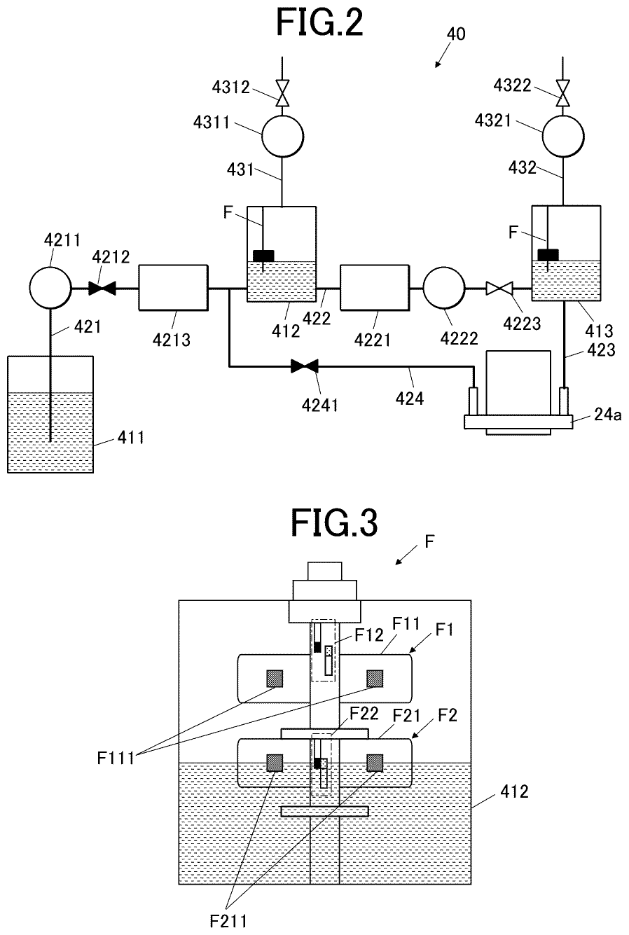

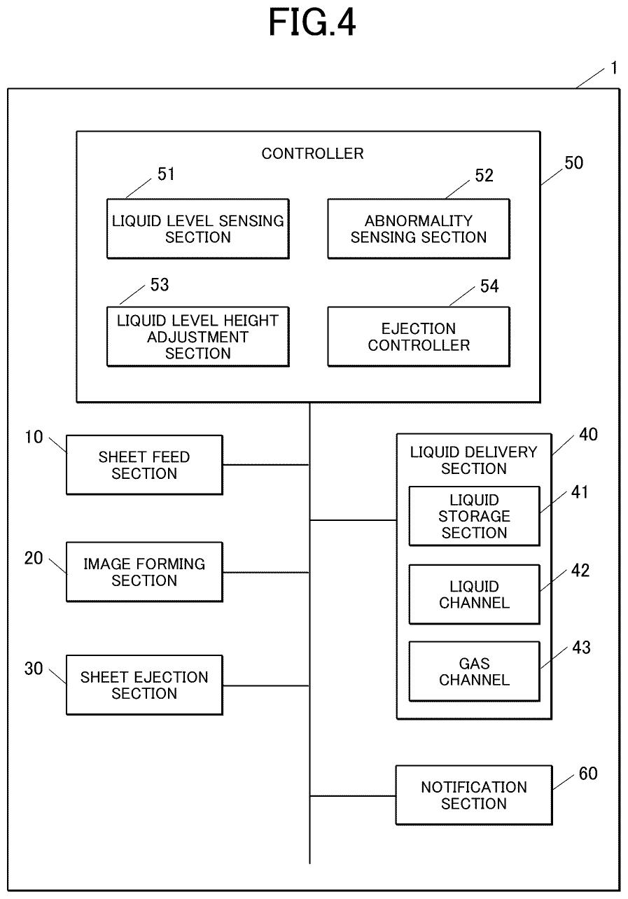

FIG. 1 is a cross-sectional side view illustrating a main configuration of an inkjet recording apparatus 1 which is an embodiment of a liquid ejection apparatus of the present disclosure. The inkjet recording apparatus 1 includes a sheet feed section 10, an image forming section 20, a sheet ejection section 30, a liquid delivery section 40 (see FIG. 2), a controller 50 (hardware processor), and a notification section 60 (see FIG. 4 for all).

Under the control of the controller 50, the inkjet recording apparatus 1 conveys a recording medium from the sheet feed section 10 to the image forming section 20. Then, the controller 50 causes the image forming section 20 to form an image on a recording medium with ink supplied from the liquid delivery section 40. After image formation, the controller 50 discharges the recording medium to the sheet ejection section 30.

Note that the recording medium is not limited to paper such as plain paper and coated paper. As the recording medium, various media can be used in which ink landed on a surface can be fixed, such as textile or sheet-like resin.

In the following description, an X direction, a Y direction, and a Z direction are directions illustrated in FIG. 1. In the following description, the X direction, the Y direction, and the Z direction are also referred to as a width direction, a conveyance direction, and a height direction, respectively.

### (Sheet Feed Section)

The sheet feed section 10 stores the recording medium before the image formation. The sheet feed section 10 conveys the recording medium to the image forming section 20 under the control of the controller 50. The sheet feed section 10 includes a sheet feed tray 11 and a conveyance section 12.

### {Sheet Feed Tray}

The sheet feed tray 11 is a plate member that stores the recording medium. The sheet feed tray 11 is provided so that one or a plurality of recording medium can be placed thereon. The sheet feed tray 11 moves up and down in accordance with an amount of the recording medium placed thereon. By such vertical movement, the sheet feed tray 11 is held at a position where an uppermost recording medium is conveyed by the conveyance section 12.

### {Conveyance Section}

The conveyance section 12 conveys the recording medium from the sheet feed tray 11 to the image forming section 20. The conveyance section 12 includes a conveyance mechanism. The conveyance mechanism drives a belt 123 to convey the recording medium on the belt 123. The belt 123 has a ring shape, and the inner side of the ring is supported by a plurality of rollers 121 and 122. The conveyance section 12 delivers the uppermost recording medium placed on the sheet feed tray 11 onto the belt 123, and conveys the recording medium along the belt 123.

### (Image Forming Section)

The image forming section 20 records the image on the recording medium in cooperation with the liquid delivery section 40 under the control of the controller 50. The image forming section 20 includes an image forming drum 21, a handover unit 22, a sheet heating section 23, a head unit 24, an irradiation section 25, and a delivery section 26.

### {Image Forming Drum}

The image forming drum 21 conveys the recording medium along a cylindrical outer periphery surface, and conveys the recording medium with rotation. A conveyance surface of the image forming drum 21 faces the sheet heating section 23, the head unit 24, and the irradiation section 25, and performs an image formation processing on the recording medium that is conveyed.

### {Handover Unit}

The handover unit 22 is provided in a position between the conveyance section 12 and the image forming drum 21. The handover unit 22 includes a claw 221 and a handover drum 222.

The claw 221 is a cylindrical member that holds one end of the recording medium conveyed by the conveyance section 12. The handover drum 222 is a member that guides the recording medium borne by the claw 221.

The handover unit 22 picks up the recording medium on the conveyance section 12 with the claw 221, and places the recording medium along the outer periphery surface of the handover drum 222. The handover unit 22 hands over the recording medium to the image forming drum 21 by the operation.

### {Sheet Heating Section}

The sheet heating section 23 includes, for example, a heating wire and generates heat in response to energization. The sheet heating section 23 is controlled by the controller 50 to generate heat so that the recording medium passing through the vicinity thereof reaches a predetermined temperature. The sheet heating section 23 is provided in a position in the vicinity of the outer periphery surface of the image forming drum 21 and on the upstream side of the head unit 24 in the conveyance direction of the recording medium.

A temperature sensor (not illustrated) is provided near the sheet heating section 23. With the temperature sensor, the controller 50 senses a temperature around the sheet heating section 23. Based on the sensed temperature, the controller 50 controls heat generation of the sheet heating section 23.

### {Head Unit}

The head unit 24 includes, for example, a plurality of inkjet heads 24a (ink ejector) (see FIG. 2) which are liquid ejection sections, and a carriage on which the inkjet heads 24a are mounted. The head unit 24 forms the image by ejecting ink droplets onto the recording medium from a nozzle. The head units 24 corresponding to the colors of C (cyan), M (magenta), Y (yellow), and K (black) are provided for each color. In FIG. 1, the head unit 24 corresponding to the respective colors of Y, M, C, and K are provided in this order from upstream with respect to the conveyance direction of the recording medium.

A plurality of head units 24 of the present embodiment are provided so as to be arranged with a length (width) that covers the entire recording medium in the width direction. That is, the inkjet recording apparatus 1 is a one-pass line-head type inkjet recording apparatus. The head unit 24 is configured by arranging a plurality of inkjet heads 24a which are droplet ejection heads. The number of the head units 24 may be equal to or greater than 5 or equal to or less than 3. Further, a single inkjet head 24a may constitute the head unit 24.

The ink ejected by the head unit 24 is, for example, ultraviolet curable ink (UV ink). The ultraviolet curable ink contains, for example, an ultraviolet curable resin. The ultraviolet curable resin contains a monomer and a polymerization initiator. When the ink containing the ultraviolet curable resin is irradiated with ultraviolet rays, the monomer is polymerized and cured by the action of the polymerization initiator, and the ink is fixed to the recording medium.

The ink ejected by the head unit 24 may be gel ink containing a gelling agent. The gel ink changes in phase between a gel state and a liquid (sol) state depending on the temperature. The gel ink has a phase change temperature of, for example, about 40 to 100° C., and is uniformly liquefied (solated) by being heated to the phase change temperature or higher. On the other hand, the gel ink is gelled at about normal room temperature, that is, about 0 to 30° C. Therefore, the ink in the head unit 24 is heated to an appropriate temperature by an ink heater or the like (not illustrated) to be brought into a sol state. Then, after the ink is ejected and the ink lands on the recording medium, the ink is moderately transferred to a gel state while the recording medium is conveyed by the image forming drum 21.

### {Irradiation Section}

The irradiation section 25 includes, for example, a fluorescent tube such as a low-pressure mercury lamp. The irradiation section 25 emits energy rays such as ultraviolet rays by light emission of the fluorescent tube. The irradiation section 25 is provided near the outer peripheral surface of the image forming drum 21. In addition, the irradiation section 25 is provided so as to be positioned on the downstream side of the head unit 24 in the conveyance direction of the recording medium. The irradiation section 25 irradiates the recording medium on which the ink has been ejected with energy rays. In a case where the ink on the recording medium is UV ink, the ink is cured by the action of the energy rays.

The fluorescent tube that emits ultraviolet rays is not limited to the low-pressure mercury lamp. The fluorescent tube may be a mercury lamp having an operating pressure of a few hundred Pa to 1 MPa, for example. The fluorescent tube may be a light source usable as a bactericidal lamp, for example, a cold-cathode tube, an ultraviolet laser light source, a metal halide lamp, a light-emitting diode, or the like. The fluorescent tube is desirably a power saving light source capable of emitting ultraviolet rays with higher illuminance. The fluorescent tube is, for example, the light-emitting diode. The energy rays are not limited to the ultraviolet rays and may be the energy rays having a property of curing the ink depending on the property of the ink. The light source is substituted depending on the energy rays.

In the above description, the case where the head unit 24 ejects the ultraviolet curable ink or the ink containing the gelling agent is exemplified, but the invention is not limited thereto. The ink ejected by the head unit 24 may be water-based ink or ink having other physical properties.

### {Delivery Section}

The delivery section 26 includes a conveyance mechanism. The conveyance mechanism drives a ring-shaped belt 263 whose inner side is supported by a plurality of rollers 261 and 262 to convey the recording medium. The delivery section 26 includes a cylindrical handover roller 264. The handover roller 264 hands over the recording medium from the image forming drum 21 to the conveyance mechanism. The delivery section 26 conveys the recording medium delivered onto the belt 263 by the handover roller 264, and sends it to the sheet ejection section 30.

### (Sheet Ejection Section)

The recording medium on which the image is formed by the image forming section 20 is ejected to the sheet ejection section 30. The sheet ejection section 30 includes a plate-shaped sheet ejection tray 31. The recording medium sent from the image forming section 20 by the delivery section 26 is placed on the sheet ejection tray 31. The sheet ejection section 30 stores the recording medium until the user takes out the recording medium.

### (Liquid Delivery Section)

FIG. 2 shows a schematic configuration of the liquid delivery section 40. FIG. 2 shows only one inkjet head 24a, and other plurality of inkjet heads 24a are omitted. The liquid delivery section 40 includes a liquid storage section (liquid storage) 41, a liquid channel 42, and a gas channel 43 (all of which are illustrated in FIG. 4).

### {Liquid Storage Section}

The liquid storage section 41 stores ink therein. The liquid storage section 41 is made of metal, for example, and has a rigid body sealing structure. The liquid storage section 41 includes a main tank 411, a first sub-tank 412, and a second sub-tank 413.

### [Main Tank]

The main tank 411 stores each color ink to be supplied to each portion of the liquid delivery section 40. Although omitted in FIG. 2, the main tank 411 is provided individually for each color of ink. The ink is supplied to an inkjet head 24a via a first liquid channel 421, the first sub-tank 412, a second liquid channel 422, the second sub-tank 413, and a third liquid channel 423, which will be described later. The main tank 411 is entirely replaceable, and is formed so as to be attachable to and detachable from the first liquid channel 421 regardless of an operating status of a first liquid delivery pump 4211 (liquid deliverer) which will be described later.

### [First Sub-Tank]

The first sub-tank 412 is a first liquid storage section that temporarily stores the ink supplied from the main tank 411. Since the liquid delivery section 40 includes the first sub-tank 412, a pressure change due to pulsation when the first liquid delivery pump 4211 supplies the ink in the main tank 411 is alleviated. Furthermore, the first sub-tank 412 is connected to an outlet of the inkjet head 24a via a fourth liquid channel 424 which will be described later. Therefore, the ink that is not discharged from the inkjet head 24a is collected into the first sub-tank 412.

### [Second Sub-Tank]

The second sub-tank 413 is a second liquid storage section that temporarily stores the ink to be delivered to the inkjet head 24a. The second sub-tank 413 is provided with a back pressure pump 4321 which will be described later. When the back pressure pump 4321 applies an appropriate negative pressure to the inkjet head 24a, head menisci are generated in the nozzles of the inkjet head 24a, and the ink is prevented from leaking from the nozzles at timings other than during image formation and during various types of maintenance.

Note that in the following description, the first sub-tank 412 and the second sub-tank 413 will be simply referred to as “sub-tank” unless otherwise distinguished from each other.

### <Liquid Level Sensor>

The sub-tanks are each provided with a liquid level sensor F (measurer). The liquid level sensor F measures a liquid level height in the sub-tank to which the liquid level sensor F is attached. Specifically, the liquid level sensor F measures a liquid level position in the sub-tank and transmits the data to the controller 50.

A detailed configuration of the liquid level sensor F according to the present embodiment is illustrated in FIG. 3. As shown in FIG. 3, for example, the liquid level sensor F includes a first measurement section F1 which measures that the liquid level height in the sub-tank becomes a maximum value and a second measurement section F2 which measures that the liquid level height in the sub-tank becomes a minimum value.

The first measurement section F1 and the second measurement section F2 are so-called float switches, and include floats F11, F21, and reed switches F12, F22, respectively. The reed switch F12, F22 is connected to the controller 50 via a signal line (not illustrated), and transmits a sensor signal to the controller 50 when contacts are connected to each other and are in an ON state. The floats F11 and F21 include specific gravities floating on the liquid in the sub-tank, and move up and down according to a change in a liquid amount in the sub-tank. Further, the floats F11 and F21 are provided with magnets F111 and F211 which are permanent magnets, respectively, and sense the displacement of the floats F11 and F21 together with the reed switches F12 and F22 to detect the liquid level height.

More specifically, when the floats F11 and F21 move to predetermined positions due to the change in the liquid amount in the sub-tank, the magnets F111 and F211 approach and act on the reed switches F12 and F22. Then, the contacts of the reed switches F12 and F22 are connected to each other to be in the ON state. Thus, a sensor state signal is output from the reed switch F12 or F22 to the controller 50, and the controller 50 senses that the liquid level height in the sub-tank has reached a predetermined value.

Note that the liquid level sensor F for measuring the liquid level height in the sub-tank is not limited to the float sensor including the floats F11 and F21 and the reed switches F12 and F22. For example, the liquid level height in the sub-tank may be measured by a capacitive sensor using an electric field.

Furthermore, although the first sub-tank 412 is illustrated in FIG. 3, the liquid level sensor F is also attached to the second sub-tank 413 in a similar manner, as illustrated in FIG. 2.

Furthermore, the sub-tank is provided with an ink heating section (not illustrated) that maintains the ink inside at an appropriate temperature. The ink heating section is constituted of a heater, a heat transfer member that transfers heat from the heater, and the like. As the heater constituting the ink heating section, a heating wire that generates Joule heat by energization is used, for example. As the heat transfer member constituting the ink heating section, a member having a high heat conductivity, such as a heat conductive plate formed of various metals (alloys) is used, for example.

### {Liquid Channel}

Returning to FIG. 2, the liquid channel 42 is an ink channel which communicates from the main tank 411 to the inkjet head 24a so as to be able to circulate liquid. The liquid channel 42 includes the first liquid channel 421, the second liquid channel 422, the third liquid channel 423, and the fourth liquid channel 424. The liquid channel 42 preferably has ink resistance, and has a hollow annular tube structure.

### [First Liquid Channel]

The first liquid channel 421 is a channel through which the main tank 411 and the first sub-tank 412 communicate with each other. The first liquid channel 421 is provided with a first liquid delivery pump 4211, a supply valve 4212, and a dissolving section 4213.

### <First Liquid Delivery Pump>

The first liquid delivery pump 4211 delivers the ink in the main tank 411 to the first sub-tank 412. As a result of measurement by the liquid level sensor F provided in the first sub-tank 412, when it is detected that the liquid amount in the first sub-tank 412 is a predetermined lower limit value, the controller 50 drives the first liquid delivery pump 4211 for a predetermined amount of time. By the control, the controller 50 delivers the ink in the main tank 411 to the first sub-tank 412.

The first liquid delivery pump 4211 is, for example, a pump, but is not limited thereto. In a case where the first liquid delivery pump 4211 is the pump, a diaphragm pump is preferable from a viewpoint of durability, cost, size, abundance of types, and the like.

### <Supply Valve>

The supply valve 4212 is, for example, an electromagnetic valve. The supply valve 4212 selectively opens the first liquid channel 421 during driving of the first liquid delivery pump 4211 under the control of the controller 50.

### <Dissolving Section>

The dissolving section 4213 is, for example, an ink heater or the like. Under the control of the controller 50, the dissolving section 4213 heats the ink flowing through the first liquid channel 421 to a predetermined temperature and lowers a viscosity of the ink.

### [Second Liquid Channel]

The second liquid channel 422 is a liquid channel that connects the first sub-tank 412 and the second sub-tank 413. The second liquid channel 422 is provided with a deaeration module 4221, a second liquid delivery pump 4222, and a first circulation valve 4223.

### <Deaeration Module>

The deaeration module 4221 includes, for example, a gas permeable film that is depressurized by being brought into an airtight state and then sucking the air inside. Next, the gas permeable film is brought into contact with the ink, so that the dissolved gas in the ink permeates the gas permeable film due to a pressure difference, and the dissolved gas in the ink that has passed through is removed. The deaeration module 4221 is not limited to the above-described so-called external reflux type, but may be an internal reflux type or any other known type that does not use the gas permeable film.

### <Second Liquid Delivery Pump>

The second liquid delivery pump 4222 is a first liquid delivery section that delivers the ink in the first sub-tank 412 to the second sub-tank 413. As a result of measurement by the liquid level sensor F provided in the second sub-tank 413, when it is detected that the liquid level height in the second sub-tank 413 is a predetermined lower limit value, the controller 50 drives the second liquid delivery pump 4222 for a predetermined amount of time and delivers the ink in the first sub-tank 412. For the same reason as the first liquid delivery pump 4211, when the second liquid delivery pump 4222 is the pump, it is particularly preferable that the pump is a diaphragm pump.

### <First Circulation Valve>

The first circulation valve 4223 is an electromagnetic valve, and selectively opens the second liquid channel 422 when the second liquid delivery pump 4222 is driven.

### [Third Liquid Channel and Fourth Liquid Channel]

The third liquid channel 423 is a channel that connects the second sub-tank 413 and an inlet of the inkjet head 24a. Furthermore, the fourth liquid channel 424 is a channel that connects the outlet of the inkjet head 24a and the first sub-tank 412. The fourth liquid channel 424 is provided with a second circulation valve 4241 which is an electromagnetic valve. The second circulation valve 4241 selectively opens the fourth liquid channel 424 when the ink is circulated from the inkjet head 24a to the first sub-tank 412, under the control of the controller 50.

### {Gas Channel}

The gas channel 43 has a hollow annular tube structure, and is provided so as to communicate a gas storage section above the liquid storage sections 41. The gas channel 43 includes a first gas channel 431 and a second gas channel 432.

### [First Gas Channel]

The first gas channel 431 is a channel of gas that communicates with the gas storage section of the first sub-tank 412. The first gas channel 431 includes a pneumatic pump 4311 and a first air release valve 4312.

### <Pneumatic Pump>

The pneumatic pump 4311 is under the control of the controller 50, is not usually driven during ink ejection, and reduces the pressure in the first sub-tank 412 by sucking the gas in the first sub-tank 412 via the first gas channel 431 during maintenance.

### <First Air Release Valve>

The first air release valve 4312 is an electromagnetic valve that opens and closes under the control of the controller 50, and allows the first gas channel 431 to communicate with the atmosphere when the pneumatic pump 4311 is driven.

### [Second Gas Channel]

The second gas channel 432 is a gas channel that communicates with the gas storage section of the second sub-tank 413. The second gas channel 432 includes a back pressure pump 4321 and a second air release valve 4322.

### <Back Pressure Pump>

The back pressure pump 4321 is driven under the control of the controller 50 so as to apply a predetermined negative pressure to the inside of the second sub-tank 413 and the nozzles of the inkjet head 24a.

### <Second Air Release Valve>

The second air release valve 4322 is an electromagnetic valve that opens and closes under the control of the controller 50, and causes the second gas channel 432 to communicate with the atmosphere when the back pressure pump 4321 is driven. In addition, the controller 50 sets the inside of the second sub-tank 413 to the atmospheric pressure by setting the second air release valve 4322 to the open state when the back pressure pump 4321 is stopped.

Note that although FIG. 2 illustrates, as an example, the configuration in which the first sub-tank 412 and the second sub-tank 413 include the first gas channel 431 and the second gas channel 432 that are independent of each other, the configuration is not limited to this. For example, the gas channel that allows the first gas channel 431 and the second gas channel 432 to communicate with each other may be provided.

### (Controller)

FIG. 4 is a block diagram illustrating a configuration of the inkjet recording apparatus 1. The controller 50 controls the components constituting the inkjet recording apparatus 1. As shown in FIG. 4, the controller 50 is connected to each section constituting the inkjet recording apparatus 1.

The controller 50 includes a central processing unit (CPU), a random access memory (RAM), a read only memory (ROM), and the like. The CPU reads various programs and data corresponding to processing contents from a storage device of the ROM or the like and executes them. In addition, the CPU controls the operation of each unit of the inkjet recording apparatus 1 according to the executed processing content. The RAM temporarily stores various programs, data, and the like to be processed by the CPU. The ROM is a nonvolatile storage device such as a hard disk drive (HDD), a solid state drive (SSD), or a flash memory, and stores various programs, data, and the like read by the CPU or the like.

In particular, the controller 50 functions as a liquid level sensing section 51, an abnormality sensing section 52, a liquid level height adjustment section 53, and an ejection controller 54 by the CPU executing a program.

### {Liquid Level Sensing Section}

The liquid level sensing section 51 acquires a sensing result of the liquid level sensor F to acquire the liquid level height in the sub-tank where the liquid level sensor F is provided. According to the present embodiment, as described above, the liquid level sensing section 51 senses that the liquid level height in the sub-tank has reached a predetermined value based on the sensor state signals output from the reed switches F12 and F22.

### {Abnormality Sensing Section}

The abnormality sensing section 52 controls driving of the second liquid delivery pump 4222 to deliver the ink in the first sub-tank 412 to the second sub-tank 413, thereby sensing occurrence of an abnormality, such as clogging, in the second liquid channel 422.

For example, the abnormality sensing section 52 performs the abnormality occurrence sensing processing at a predetermined timing. The abnormality sensing section 52 performs the abnormality occurrence sensing process, for example, at a timing between two image formation processing. Alternatively, the abnormality sensing section 52 performs the abnormality occurrence sensing processing, for example, at a timing of maintenance of the inkjet head 24a. Alternatively, the abnormality sensing section 52 performs the abnormality occurrence sensing processing at a timing when the inkjet recording apparatus 1 is activated.

The abnormality sensing section 52 drives the second liquid delivery pump 4222 at a predetermined output for a predetermined time period to deliver the ink in the first sub-tank 412 to the second sub-tank 413. The ROM stores, on the basis of an experiment performed in advance, an increase amount of the liquid level height in the second sub-tank 413 corresponding to predetermined conditions (including not only the output of the second liquid delivery pump 4222 and time but also temperature, composition, and the like of ink). The abnormality sensing section 52 senses occurrence of abnormality in the second liquid channel 422 according to whether an increase amount of the liquid level height in the second sub-tank 413 based on the sensing result of the liquid level sensor F is a predetermined value or more, in other words, whether a difference from the increase amount based on the experiment described above is within a predetermined value.

### {Liquid Level Height Adjustment Section}

The liquid level height adjustment section 53 adjusts the liquid level height in the second sub-tank 413 in channel abnormality sensing processing for the second liquid channel 422 by the abnormality sensing section 52, and with this, suppresses the ink overflowing from the second sub-tank 413 and then contaminating the second gas channel 432. Detailed adjustment content of the liquid level height in the second sub-tank 413 by the liquid level height adjustment section 53 will be described later.

### {Ejection Controller}

The ejection controller 54 outputs a drive signal for operating an ink ejection mechanism in each inkjet head 24a, and performs control so that the ink is ejected from the nozzles of each inkjet head 24a at an appropriate timing. Specifically, upon receiving an ink ejection-related signal (print job) from an external device (not illustrated), the ejection controller 54 outputs a drive signal for operating the ink ejection mechanism in each inkjet head 24a at the timing corresponding to the conveyance speed of the image forming drum 21. As the ink ejection mechanism of the inkjet head 24a, for example, a piezoelectric mechanism or a thermal mechanism may be used, but the ink ejection mechanism is not particularly limited.

### [Notification Section]

The notification section 60 provides notification of various types of information under the control of the controller 50. The notification section 60 is, for example, a display part having a screen, a speaker that emits a predetermined sound, or a communication section that can communicate with another device via a network.

### [Channel Abnormality Sensing Process]

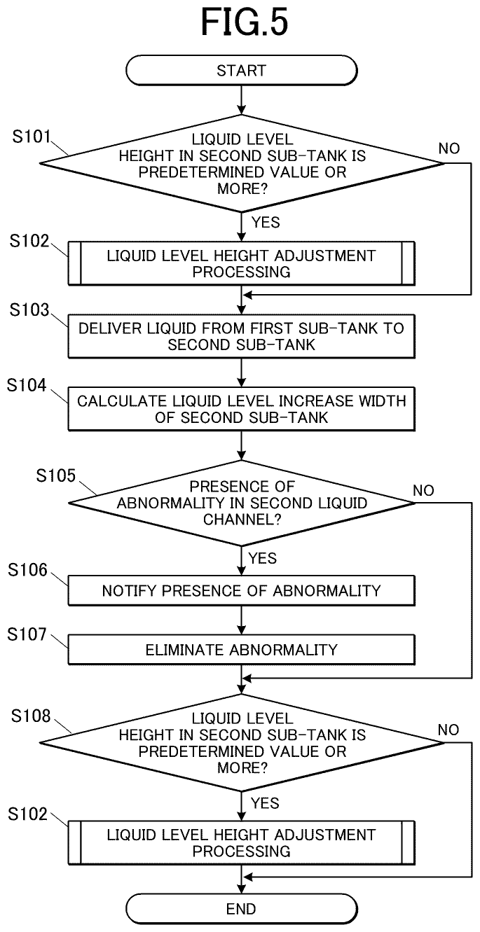

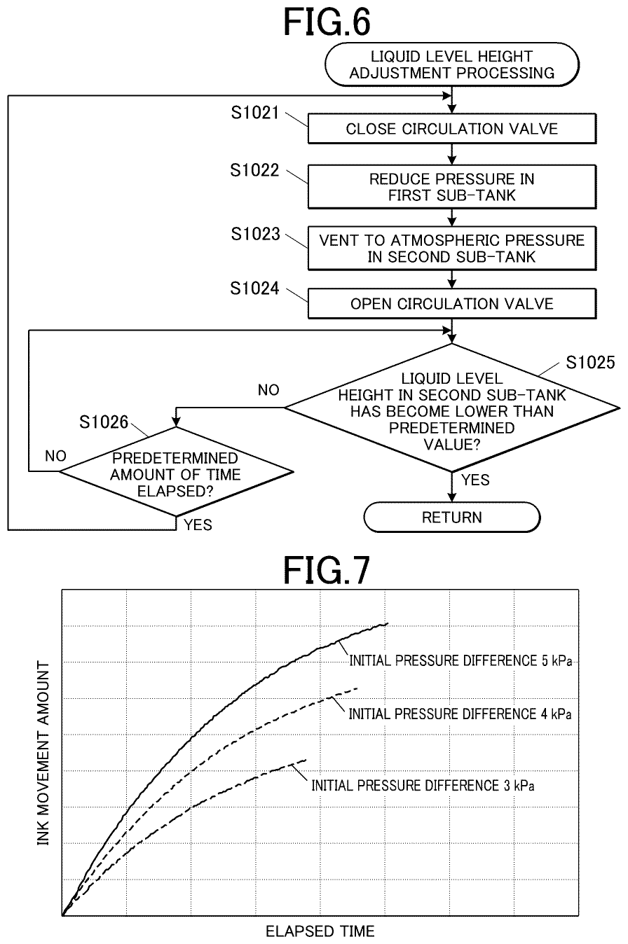

The channel abnormality sensing processing by the controller 50 of the inkjet recording apparatus 1 will be described with reference to the flowcharts shown in FIG. 5 and FIG. 6. In the liquid delivery section 40 as described above, for example, when an abnormality such as clogging exists in the second liquid channel 422, the liquid delivery from the first sub-tank 412 to the second sub-tank 413 is not sufficiently performed. Therefore, the abnormality sensing section 52 of the inkjet recording apparatus 1 according to the present embodiment senses whether the abnormality exists in the second liquid channel 422, and if the abnormality exists, allows the user to remove the abnormality.

As described above, according to the present processing, the abnormality sensing section 52 determines the presence or absence of the abnormality in the second liquid channel 422 according to whether or not the increase amount of the ink in the second sub-tank 413 is equal to or more than the predetermined value when the ink is delivered from the first sub-tank 412 to the second sub-tank 413. At the time of the liquid delivery, if the ink amount stored in the second sub-tank 413 in advance is large, the ink may overflow from the second sub-tank 413 and contaminate the second gas channel 432.

Therefore, in the channel abnormality sensing process, first, the liquid level height adjustment section 53 determines whether or not the liquid level height in the second sub-tank 413 is equal to or greater than the predetermined value based on the sensing result of the liquid level sensing section 51 (step S101). In the present embodiment, specifically, the liquid level height adjustment section 53 determines whether or not the liquid level height in the second sub-tank 413 is equal to or higher than 50% of the height from the bottom surface of the second sub-tank 413.

In a case where the liquid level height in the second sub-tank 413 is equal to or greater than the predetermined value (step S102; Yes), the liquid level height adjustment section 53 performs a liquid level height adjustment process of adjusting the liquid level height in the second sub-tank 413 (step S102; liquid level height adjustment step).

A flowchart of the liquid level height adjustment processing is illustrated in FIG. 6. First, the liquid level height adjustment section 53 sets the first circulation valve 4223 to a closed state (step S1021). Through the control, fluctuations in the pressures in one of the liquid storage sections 41 in step S1022 and step S1023 described later are inhibited from affecting pressure values in the other liquid storage section 41.

The liquid level height adjustment section 53 reduces the pressure in the first sub-tank 412 to be in a negative pressure state by driving the pneumatic pump 4311 in a state where the first air release valve 4312 is in the open state (step S1022).

In addition, the liquid level height adjustment section 53 stops the back pressure pump 4321 and then sets the second air release valve 4322 to the open state, and with this, the inside of the second sub-tank 413 is set to the atmosphere pressure (0 kPa) (step S1023).

Note that in step S1022 and step S1023, it is sufficient that a pressure difference is provided such that the pressure value in the first sub-tank 412 is smaller than the pressure value in the second sub-tank 413. Therefore, any one of step S1022 and step S1023 may be performed first.

After the adjustment of the pressure values in the first sub-tank 412 and the second sub-tank 413, the liquid level height adjustment section 53 sets the first circulation valve 4223 to the open state (step S1024). As described above, the pressure in the first sub-tank 412 is negative by step S1022, and the pressure in the second sub-tank 413 is atmospheric by step S1023. Therefore, when the first circulation valve 4223 is set to the open state, the ink contained in the second sub-tank 413 is drawn into the first sub-tank 412 via the second liquid channel 422 due to the pressure difference between the two liquid storage sections 41.

The graph of FIG. 7 is a graph which shows changes in a liquid delivery amount due to the pressure difference between the pressure in the first sub-tank 412 and the pressure in the second sub-tank 413 and elapsed time. In FIG. 7, a horizontal axis represents the elapsed time, and a vertical axis represents an accumulated value of an ink movement amount. As illustrated in FIG. 7, as the pressure difference between the pressure in the first sub-tank 412 and the pressure in the second sub-tank 413 (initial pressure difference) is increased in step S1022 and step S1023, the liquid delivery speed in step S1024 increases correspondingly, and the movement amount increases. Therefore, it is preferable to increase the pressure difference between the pressure in the first sub-tank 412 and the pressure in the second sub-tank 413 because the number of times of execution of the liquid level height adjustment processing decreases and the downtime decreases.

On the other hand, it is preferable to control the pressure value in the first sub-tank 412 to be equal to or higher than −4 kPa and lower than 0 kPa in step S1022 and to control the pressure value in the second sub-tank 413 to be higher than −4 kPa and equal to or lower than 0 kPa in step S1023.

This is because if the pressure value in the first sub-tank 412 is less than −4 kPa, air enters from the nozzles of the inkjet head 24a, and an image defect occurs. On the other hand, if the pressure value in the second sub-tank 413 is made larger than 0 kPa, the ink overflows from the nozzle in the inkjet head 24 a, thus causing ink loss. Therefore, it is preferable that the liquid level height adjustment section 53 increases the pressure difference between the pressure in the first sub-tank 412 and the pressure in the second sub-tank 413 within the above range.

Referring back to FIG. 6, the liquid level height adjustment section 53 determines, based on the measurement result of the liquid level sensor F, whether the liquid level height in the second sub-tank 413 has become lower than a predetermined value (step S1025). The predetermined value in step S1025 is 50% from the bottom surface of the second sub-tank 413 similarly to step S101.

When the liquid level height in the second sub-tank 413 is not lower than the predetermined value (step S1025; No), the liquid level height adjustment section 53 determines whether or not a predetermined amount of time has elapsed from the opening of the first circulation valve 4223 (step S1026).

In a case where the predetermined amount of time has not elapsed from the opening of the first circulation valve 4223 (step S1026; No), the liquid level height adjustment section 53 transitions to step S1025 and continues to wait. When the predetermined amount of time has elapsed since the opening of the first circulation valve 4223 (step S1026; Yes), the liquid level height adjustment section 53 proceeds to step S1021 and performs the above-described processing again in order to further decrease the liquid level height in the second sub-tank 413.

When the liquid level height in the second sub-tank 413 is less than the predetermined value (step S1025; Yes), the liquid level height adjustment section 53 completes the liquid level height adjustment processing.

Returning to FIG. 5, in a case where the liquid level height adjustment section 53 completes the liquid level height adjustment process, or in a case where the liquid level height in the second sub-tank 413 is originally less than the predetermined value (step S101; No), the abnormality sensing section 52 determines the presence or absence of the abnormality in the second liquid channel 422. Specifically, first, the abnormality sensing section 52 drives the second liquid delivery pump 4222 to deliver the ink in the first sub-tank 412 to the second sub-tank 413 (step S103).

The abnormality sensing section 52 calculates a liquid level increase width of the second sub-tank 413 (step S104). Specifically, the abnormality sensing section 52 acquires the liquid level height in the second sub-tank 413 from the liquid level sensing section 51 immediately before step S103. Further, the abnormality sensing section 52 acquires the liquid level height in the second sub-tank 413 from the liquid level sensing section 51 immediately after step S103. Then, the abnormality sensing section 52 calculates the liquid level increase width of the second sub-tank 413 from the difference between the two.

The abnormality sensing section 52 compares the liquid delivery amount to the second sub-tank 413 in step S103 with the liquid level increase width of the second sub-tank 413 calculated in step S104. Then, based on the difference, the presence or absence of the abnormality in the second liquid channel 422 is determined (step S105; abnormality sensing step).

When it is determined that the abnormality exists in the second liquid channel 422 (step S105; Yes), the abnormality sensing section 52 stops the operation of the inkjet recording apparatus 1 and causes the notification section 60 to provide notification that the abnormality exists in the second liquid channel 422 (step S106). The user who has confirmed the notification eliminates the abnormality by contacting, for example, a service engineer (step S107).

After elimination of the abnormality in the second liquid channel 422, or the abnormality sensing section 52 determines that there is no abnormality in the second liquid channel 422 (step S105; No), the image formation processing by the ink ejection can be performed without any problems. On the other hand, a large amount of the ink is stored in the second sub-tank 413 by the liquid delivery to the second sub-tank 413 in step S103. Therefore, in subsequent image formation, for example, when the print job is acquired to form the image with high ink consumption and a large amount of ink is delivered from the first sub-tank 412, the ink may overflow from the second sub-tank 413 and contaminate the second gas channel 432.

Therefore, the liquid level height adjustment section 53 determines again, based on the sensing result of the liquid level sensing section 51, whether the liquid level height in the second sub-tank 413 is higher than or equal to the predetermined value (step S108). When the liquid level height in the second sub-tank 413 is higher than or equal to the predetermined value (step S108; Yes), the liquid level height adjustment processing is performed again to adjust the liquid level height in the second sub-tank 413 to be within the predetermined range (step S102). When the liquid level height in the second sub-tank 413 is less than the predetermined value (step S108; No), the liquid level height adjustment processing in the second sub-tank 413 is not necessary, and thus the channel abnormality sensing processing is ended as it is.

Note that the adjustment of the liquid level height in the second sub-tank 413 after the sensing of the presence or absence of the abnormality in the second liquid channel 422 by the abnormality sensing section 52 may be performed immediately after the abnormality sensing processing as described above, but is not limited thereto. For example, a configuration may be adopted in which, after the abnormality sensing processing and at a timing when the ejection controller 54 acquires the print job involving the ejection of the ink by the inkjet head 24a from the external device (not illustrated), the liquid level height adjustment section 53 adjusts the liquid level height in the second sub-tank 413.

### Effects of Embodiment

As described above, according to the present embodiment, the inkjet recording apparatus 1 includes the inkjet head 24a to eject ink, and the liquid delivery section 40 to deliver the ink to the inkjet head 24a. The liquid delivery section 40 includes the first sub-tank 412 and the second sub-tank 413 that store the liquid. Furthermore, the liquid delivery section 40 includes the second liquid channel 422 including the second liquid delivery pump 4222 that delivers the ink in the first sub-tank 412 to the second sub-tank 413. The inkjet recording apparatus 1 includes the abnormality sensing section 52 that senses the abnormality of the second liquid channel 422 based on the liquid delivery by the second liquid delivery pump 4222. The inkjet recording apparatus 1 further includes the liquid level height adjustment section 53 that reduces the liquid level height in the second liquid storage section by discharging the liquid in the second liquid storage section when the predetermined condition is satisfied. According to the above-described configuration, since the liquid level height adjustment section 53 reduces the liquid level height in the second sub-tank 413 that is on the side receiving the delivered liquid, the overflow of the liquid in the second sub-tank 413 can be suppressed. In addition, as the control of the inkjet recording apparatus 1, since the liquid level height adjustment section 53 reduces the liquid level height in the second sub-tank 413, it is also possible to suppress a decrease in productivity due to the driving stop of the inkjet recording apparatus 1.

The predetermined condition is that it is before execution of the abnormality sensing processing by the abnormality sensing section 52. According to the above-described configuration, it is possible to suppress the overflow of the liquid in the second sub-tank 413 due to the delivery of the liquid from the first sub-tank 412 to the second sub-tank 413 in the abnormality sensing processing.

The inkjet recording apparatus 1 includes the ejection controller 54 to control the ink ejection by the inkjet head 24a. The predetermined condition is that it is after the abnormality sensing section 52 has delivered the liquid in the first sub-tank 412 into the second sub-tank 413 by the second liquid delivery pump 4222, and that the ejection controller 54 has received an instruction to eject the liquid from the inkjet head 24a. According to the above-described configuration, it is possible to suppress the overflow of the liquid in the second sub-tank 413 due to the fact that, after the liquid is delivered from the first sub-tank 412 to the second sub-tank 413, the liquid is further delivered from the first sub-tank 412 to the second sub-tank 413.

Furthermore, the inkjet recording apparatus 1 includes a liquid level sensing section 51 that senses the liquid level height of the second sub-tank 413. The predetermined condition is that the liquid level sensing section 51 senses that the liquid level height in the second sub-tank 413 is equal to or higher than the predetermined value. According to the above-described configuration, when the liquid amount in the second sub-tank 413 is the liquid amount that overflows when the liquid is delivered from the first sub-tank 412, the liquid level height in the second sub-tank 413 can be reduced to suppress the overflow of the liquid in the second sub-tank 413.

### Modification Example and the Like

Although specific description has been given above based on the embodiment according to the present disclosure, the present disclosure is not limited to the above-described embodiment. It is needless to say that the present disclosure can be subjected to various modifications including the scope of the invention described in the scope of the claims and the scope of equivalents thereof.

For example, while the configuration in which the liquid level height in the second sub-tank 413 is decreased by causing the liquid to flow backward in the second liquid channel 422 by providing the pressure difference such that the pressure value in the first sub-tank 412 is lower than the pressure value in the second sub-tank 413 has been illustrated in the above description, it is not limited thereto.

For example, as illustrated in FIG. 2, in a case of providing the fourth liquid channel 424 that is a circulation channel passing through the inkjet head 24a, the liquid may be delivered from the second sub-tank 413 to the first sub-tank 412 via the fourth liquid channel 424. Specifically, after the ink in the second sub-tank 413 is delivered to the inkjet head 24a, the pressure in the first sub-tank 412 is reduced and the second circulation valve 4241 is opened, so that the ink can be delivered to the first sub-tank 412.

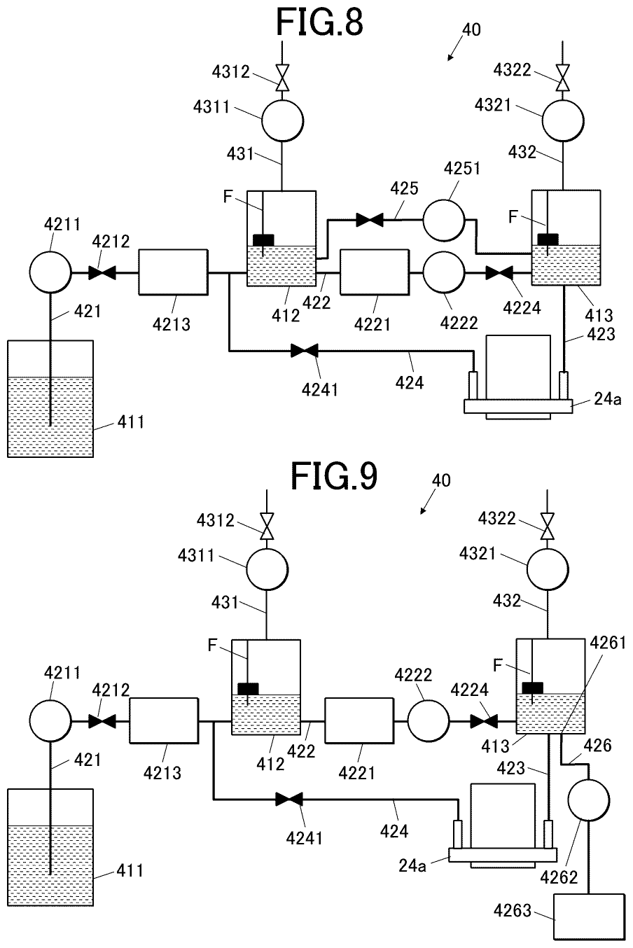

Alternatively, for example, as illustrated in FIG. 8, a fifth liquid channel 425, which is a circulation channel connecting the first sub-tank 412 and the second sub-tank 413, may be provided separately from the second liquid channel 422. In the above-described configuration, for example, driving the third liquid delivery pump 4251 provided in the fifth liquid channel 425 can deliver the ink in the second sub-tank 413 to the first sub-tank 412 and adjust the liquid level height in the second sub-tank 413. Note that also in the above-described configuration in which the fifth liquid channel 425 is provided, as described above, by providing the pressure difference between the pressure in the first sub-tank 412 and the pressure in the second sub-tank 413, the ink in the second sub-tank 413 may be delivered to the first sub-tank 412 via the fifth liquid channel 425.

Further, for example, as shown in FIG. 9, a drain channel 426 communicating with a waste ink tank 4263 may be provided in the second sub-tank 413. In the aforementioned configuration, by setting an electromagnetic valve 4261 provided in the drain channel 426 to the open state and driving the fourth liquid delivery pump 4262, the ink in the second sub-tank 413 can be discharged to the waste ink tank 4263 and the liquid level height can be adjusted in the second sub-tank 413.

Alternatively, for example, the inside of the second sub-tank 413 may be pressurized to eject the ink from the inkjet head 24a, thereby reducing the liquid level height in the second sub-tank 413.

Provided that an ink loss occurs when the ink in the second sub-tank 413 is discharged to the outside of the inkjet recording apparatus 1. Therefore, it is preferable to adopt a configuration in which the liquid level height in the second sub-tank 413 is adjusted by delivering the ink in the second sub-tank 413 to the first sub-tank 412.

Furthermore, although the case where the present disclosure is applied to the inkjet recording apparatus 1 to eject ink has been mainly illustrated above, the liquid ejection apparatus is not limited to the inkjet recording apparatus 1. That is, the configuration of the present disclosure is also applicable to a liquid ejection apparatus that ejects not only ink but also other liquids such as chemicals and a pretreatment liquid for printing.

Furthermore, in the above description, the configuration has been exemplified in which the first sub-tank 412 is the first liquid storage section, the second sub-tank 413 is the second liquid storage section, and the presence or absence of abnormality in the second liquid channel 422 connecting the both is sensed, but the present disclosure is not limited to this. With a structure in which the pressure value in the main tank 411 can be adjusted, the liquid level height in the first sub-tank 412 may be reduced when whether there is the abnormality in the first liquid channel 421 is sensed with the main tank 411 as the first liquid storage section and the first sub-tank 412 as the second liquid storage section. In the above-described configuration, the liquid in the first sub-tank 412 may be delivered to the second sub-tank 413 in order to reduce the liquid level height in the first sub-tank 412.

Furthermore, in the above description, the preferable liquid level height in the second sub-tank 413 is less than 50% of the height from a bottom surface of the second sub-tank 413, but particularly from step S108 and after, it is more preferable that the liquid level height is 20% or more of the height from the bottom surface of the second sub-tank 413. This is because if the ink amount in the second sub-tank 413 is excessively small in the subsequent ink ejection, the ink ejection might not be completed.

Furthermore, although the configuration in which the first sub-tank 412 and the second sub-tank 413 are directly connected by the second liquid channel 422 and the second sub-tank 413 and the inkjet head 24a are directly connected by the third liquid channel 423 has been described above as an example, it is not limited thereto. That is, another liquid storage section 41 and another liquid channel 42 may be provided between the first sub-tank 412 and the second sub-tank 413 or between the second sub-tank 413 and the inkjet head 24a.

According to the above description, the abnormality sensing section 52 determines whether the liquid level height in the second sub-tank 413 is equal to or higher than the predetermined value before and after performing the abnormality sensing process, and performs the liquid level height adjustment process, but the present disclosure is not limited to this. For example, control may be performed such that the liquid level height adjustment processing is performed in a case where the liquid level height in the second sub-tank 413 is a predetermined value or more.

In the above description, an example in which a hard disk, a semiconductor nonvolatile memory, or the like is used as a computer-readable medium of the program according to the present disclosure has been disclosed, but the present disclosure is not limited to this example. As another computer-readable medium, a portable recording medium such as a CD-ROM can be applied. Furthermore, a carrier wave is also applied as a medium for providing data of the program according to the present disclosure via a communication line.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. A liquid ejection apparatus comprising:
a liquid ejector that ejects liquid;
a liquid deliverer that delivers liquid to the liquid ejector; and
a hardware processor,
wherein,
the liquid deliverer includes a first liquid storage and a second liquid storage that store liquid, and a first liquid channel including a first liquid deliverer that delivers the liquid in the first liquid storage to the second liquid storage,
the hardware processor senses an abnormality of the first liquid channel based on a liquid delivery by the first liquid deliverer, and
the hardware processor is configured to, in a case in which a predetermined condition is satisfied, reduce a liquid level height in the second liquid storage by causing the liquid in the second liquid storage to be discharged.

2. The liquid ejection apparatus according to claim 1, wherein the predetermined condition is that it is before execution of abnormality sensing processing by the hardware processor.

3. The liquid ejection apparatus according to claim 1, wherein,
the hardware processor controls liquid ejection by the liquid ejector, and
the predetermined condition is that it is after the hardware processor allows the first liquid deliverer to deliver the liquid in the first liquid storage into the second liquid storage and that the hardware processor receives an instruction to eject the liquid from the liquid ejector.

4. The liquid ejection apparatus according to claim 1, wherein,
the hardware processor senses the liquid level height in the second liquid storage, and
the predetermined condition is that the hardware processor senses that the liquid level height in the second liquid storage is equal to or greater than a predetermined value.

5. The liquid ejection apparatus according to claim 4, wherein,
the predetermined value is 50% or more from a bottom surface of the second liquid storage, and
the hardware processor is configured to reduce the liquid level height in the second liquid storage to a range lower than 50% from the bottom surface of the second liquid storage.

6. The liquid ejection apparatus according to claim 1, wherein the hardware processor is configured to reduce the liquid level height in the second liquid storage by discharging the liquid in the second liquid storage to the first liquid storage.

7. The liquid ejection apparatus according to claim 6, wherein,
the liquid deliverer includes a circulation channel that is separate from the first liquid channel and that connects the first liquid storage and the second liquid storage, and
the hardware processor is configured to reduce the liquid level height in the second liquid storage by discharging the liquid in the second liquid storage to the first liquid storage via the circulation channel.

8. The liquid ejection apparatus according to claim 7, wherein the circulation channel is provided in a manner that passes through the liquid ejector.

9. The liquid ejection apparatus according to claim 8, wherein the circulation channel includes a second liquid deliverer that discharges the liquid in the second liquid storage to the first liquid storage.

10. The liquid ejection apparatus according to claim 6, wherein the hardware processor provides a pressure difference such that a pressure value in the first liquid storage is lower than the pressure value in the second liquid storage and the liquid in the second liquid storage is discharged to the first liquid storage.

11. The liquid ejection apparatus according to claim 10, wherein the hardware processor controls the pressure value in the first liquid storage to be −4 kPa or more and less than 0 kPa, and controls the pressure value in the second liquid storage to be more than −4 kPa and 0 kPa or less.

12. The liquid ejection apparatus according to claim 1, wherein the hardware processor is configured to reduce the liquid level height in the second liquid storage by discharging the liquid in the second liquid storage to an outside of the liquid ejection apparatus.

13. The liquid ejection apparatus according to claim 12, wherein,
the second liquid storage includes a drain channel that communicates with a waste liquid tank, and
the hardware processor is configured to reduce the liquid level height in the second liquid storage by discharging the liquid in the second liquid storage to the waste liquid tank.

14. The liquid ejection apparatus according to claim 12, wherein the hardware processor is configured to reduce the liquid level height in the second liquid storage by ejecting the liquid in the second liquid storage from the liquid ejector.

15. The liquid ejection apparatus according to claim 1, wherein the liquid is ink.

16. A liquid level height control method executed by a liquid ejection apparatus including a liquid ejector that ejects liquid; and a liquid deliverer that delivers liquid to the liquid ejector, wherein the liquid deliverer includes a first liquid storage and a second liquid storage that store liquid, and a first liquid channel including a first liquid deliverer that delivers the liquid in the first liquid storage to the second liquid storage, the liquid level height control method comprising:
sensing an abnormality of the first liquid channel based on a liquid delivery by the first liquid deliverer, and
in a case in which a predetermined condition is satisfied, adjusting and reducing a liquid level height in the second liquid storage by causing the liquid in the second liquid storage to be discharged.

17. A non-transitory computer-readable storage medium storing a program that causes a computer of a liquid ejection apparatus including a liquid ejector that ejects liquid; and a liquid deliverer that delivers liquid to the liquid ejector, wherein the liquid deliverer includes a first liquid storage and a second liquid storage that store liquid, and a first liquid channel including a first liquid deliverer that delivers the liquid in the first liquid storage to the second liquid storage, the program causing the computer to perform:
sensing an abnormality of the first liquid channel based on a liquid delivery by the first liquid deliverer, and
in a case in which a predetermined condition is satisfied, adjusting and reducing a liquid level height in the second liquid storage by causing the liquid in the second liquid storage to be discharged.
